(19) United States
(12) Patent Application Publication
(10) Pub. No.: US 2026/0257491 A1
(43) Pub. Date: Sep. 3, 2026

(54) PRINTING METHOD

(71) Applicant: Ricoh Company, Ltd., Tokyo (JP)

(72) Inventor: Daiki ETO, Kanagawa (JP)

(73) Assignee: Ricoh Company, Ltd., Tokyo (JP)

(21) Appl. No.: 19/658,761

(22) Filed: Apr. 27, 2026

Related U.S. Application Data
(62) Division of application No. 18/603,273, filed on Mar. 13, 2024.

(30) Foreign Application Priority Data
Mar. 24, 2023 (JP) 2023-048109
Nov. 2, 2023 (JP) 2023-188562

(51) Int. Cl. B41J 2/21; B41J 3/407; B41J 11/00; B41M 5/00

(52) U.S. Cl. CPC B41J 2/2114; B41J 3/4078; B41J 11/0015; B41M 5/0017

(57) ABSTRACT

A printing method is provided that includes: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid. The overhang region is adjacent to and upstream of the planned formation region of the printing liquid image in a movement direction of the leveling member.

### CROSS-REFERENCE TO RELATED APPLICATIONS

This patent application is a divisional of U.S. application Ser. No. 18/603,273, filed Mar. 13, 2024, which is based on and claims priority pursuant to 35 U.S.C. § 119(a) to Japanese Patent Application Nos. 2023-048109 and 2023-188562, filed on Mar. 24, 2023 and Nov. 2, 2023, respectively, in the Japan Patent Office, the entire disclosure of each of which is hereby incorporated by reference herein.

### BACKGROUND

### Technical Field

The present disclosure relates to a printing method.

### Related Art

Inkjet-type printing devices are known as printing devices that print an image (perform printing) on the surface of a fabric or the like. In this printing device, the printing of an image is performed by applying (discharging and spraying) a pretreatment liquid to a printing region on which an image is to be printed, and then applying (discharging and spraying) an ink for printing to the printing region.

A leveling step is sometimes performed after applying the pretreatment liquid. In the leveling step, a leveling member (a leveling roller, a leveling blade, or a leveling squeegee) is moved on the pretreatment liquid image.

The leveling step allows the pretreatment liquid to uniformly permeate the printing region of the medium. Furthermore, although fluffing and the like often occurs in media such as woven fabrics, the leveling step can also have the effect of smoothing out the fluffing.

On the other hand, a printing method has been disclosed that forms an overhang portion in which an edge portion of a pretreatment liquid image protrudes further toward the outside than an edge portion of a colored ink image, and forms the overhang portion such that a spraying amount per unit area (application density) of the pretreatment liquid is reduced toward the outside. This is an attempt to prevent a reduction in the image quality caused by, for example, variations in the inkjet head and the discharge conditions, variations in the viscosity of the ink and the like, and offsets between the pretreatment liquid and the colored ink due to changes over time.

### SUMMARY

A printing method according to an embodiment of the present invention includes: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid. The overhang region is adjacent to and upstream of the planned formation region of the printing liquid image in a movement direction of the leveling member.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1A is a perspective view of a printing device according to an embodiment of the present invention, which includes a leveling roller that moves in a sub-scanning direction;

FIG. 1B is a plan view of a carriage in the printing device in FIG. 1A;

FIGS. 2A and 2B are diagrams illustrating a forward motion and a return motion, respectively, of a leveling roller that moves in a sub-scanning direction;

FIG. 3A is a diagram illustrating a normal discharge pattern of a pretreatment liquid image;

FIG. 3B is a diagram illustrating a discharge pattern of a pretreatment liquid image whose shape has been changed (has been spread in a roller direction) due to application of a leveling roller to the normal discharge pattern;

FIG. 3C is a diagram illustrating a discharge pattern of a pretreatment liquid image according to an embodiment of the present invention that takes into account a change in shape caused by application of a leveling roller;

FIG. 4 is a diagram illustrating a discharge pattern of a pretreatment liquid image according to an embodiment of the present invention when application of a leveling roller is performed in two directions;

FIGS. 5A to 5C are diagrams illustrating discharge patterns of a pretreatment liquid image when application of a leveling roller is performed in only one direction, where FIG. 5A is a normal discharge pattern, FIG. 5B is a discharge pattern of a pretreatment liquid image whose shape has been changed (has been spread in a roller direction) due to application of a leveling roller to the normal discharge pattern, and FIG. 5C is a discharge pattern of a pretreatment liquid image of the present embodiment that takes into account a change in shape caused by application of a leveling roller;

FIG. 6 is a perspective view of a printing device including a leveling roller that moves in a main scanning direction;

FIG. 7A is a top view of a printing device including, at the center of the device, a leveling roller that moves in a main scanning direction;

FIG. 7B is a top view of a printing device including, on the front side of the device, a leveling roller that moves in a main scanning direction;

FIG. 7C is a top view of a carriage provided with a plurality of liquid discharge heads;

FIG. 7D is a top view of a carriage provided with a plurality of leveling rollers;

FIGS. 8A and 8B are diagrams illustrating a forward motion and a return motion, respectively, of a leveling roller that moves in a main scanning direction;

FIGS. 9A and 9B are diagrams illustrating patterns of a pretreatment liquid image when a leveling roller movement is performed in both directions without an overlap in the leveled region, where FIG. 9A is a pattern of a pretreatment liquid image whose shape has been changed (has been spread in a roller direction) when the leveling roller movement is performed with a normal pattern, and FIG. 9B is a pattern of a pretreatment liquid image according to an embodiment of the present invention that takes into account a change in shape caused by a reciprocating leveling roller movement;

FIGS. 10A and 10B are diagrams illustrating patterns of a pretreatment liquid image when a leveling roller movement is performed in both directions with a partial overlap in the leveled region, where FIG. 10A is a normal pattern, and FIG. 10B is a pattern of a pretreatment liquid image according to an embodiment of the present invention that takes into account a change in shape caused by a reciprocating leveling roller movement;

FIG. 11 is a diagram illustrating a print data creation screen of an image forming program;

FIGS. 12A and 12B are diagrams illustrating a pretreatment liquid image when the leveling roller application conditions have been changed, where FIG. 12A is a pretreatment liquid image obtained under conditions in which a pretreatment liquid is easily spread (high pressure, fast scanning speed, large number of repetitions, low temperature), and FIG. 12B is a pretreatment liquid image obtained under conditions in which a pretreatment liquid is not easily spread (low pressure, slow scanning speed, small number of repetitions, high temperature);

FIG. 13 is a perspective view of a printing device according to an embodiment of the present invention including a leveling squeegee that moves in a sub-scanning direction;

FIG. 14 is a diagram illustrating a list of droplet types of a pretreatment liquid;

FIG. 15 is a diagram illustrating a normal coating pattern of a pretreatment liquid in a printing region having two columns with different ink adhesion amounts;

FIG. 16 is a diagram illustrating a state in which the coating pattern in FIG. 15 has been spread as a result of roller application;

FIG. 17 is a diagram in which the coating pattern in FIG. 15 has been improved on an upstream side and a downstream side of the roller application;

FIG. 18 is a diagram illustrating a normal coating pattern of a pretreatment liquid in a printing region having two levels with different ink adhesion amounts;

FIG. 19 is a diagram in which the coating pattern in FIG. 18 has been improved on an upstream and downstream side and an intermediate boundary portion of the roller application;

FIG. 20 is a diagram illustrating a normal coating pattern of a pretreatment liquid in a printing region having two levels with different ink adhesion amounts; and

FIG. 21 is a diagram in which the coating pattern in FIG. 20 has been improved on upstream and downstream sides and an intermediate boundary portion of the roller application.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Hereinafter, embodiments of the present invention will be described in detail with reference to the drawings. In each of the examples and the like, the configuration elements (members and components) having the same functions, shapes, and the like, will be given the same reference numerals, and the description will be omitted after being described once unless there is a risk of confusion.

In a conventional printing method, an “offset” between a pretreatment liquid and a colored ink is prevented from occurring in a printing region of a medium. However, an “offset” that occurs in a leveling step is not considered. That is, when a medium is leveled by a leveling member, the pretreatment liquid that has soaked into the fabric is spread in the movement direction of the leveling member.

As a result, an offset occurs between the application region of the pretreatment liquid and the printing region. When an offset occurs at an edge portion of a pretreatment liquid image in the application region, a reduction in the image quality (edge portion sharpness) occurs due to the offset between the pretreatment liquid and the colored ink.

According to embodiments of the present invention, a reduction in the image quality caused by a leveling step can be suppressed.

### Printing Device

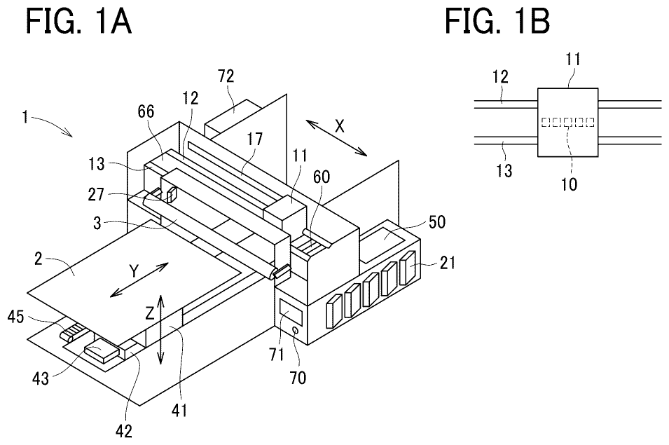

First, a printing device according to the present embodiment will be described with reference to FIGS. 1A and 1B. FIG. 1A is an external perspective view of the printing device. Note that, in FIG. 1A, the thickness of a platen 2 is ignored and is illustrated in a simplified manner.

The printing device 1 illustrated in FIG. 1A is an example of a liquid discharging device, and is a serial-type inkjet printer. The printing device 1 includes: a plurality of inkjet heads 10 (hereinafter abbreviated as “heads 10”) serving as liquid discharge heads, being a liquid discharge means that discharges a liquid; a carriage 11 to which the plurality of heads 10 are mounted and which is capable of a reciprocating movement in a main scanning direction X; a leveling roller 3 serving as a leveling member that is disposed on the front side of the carriage 11; and a platen 2 serving as a support member that supports a target printing medium.

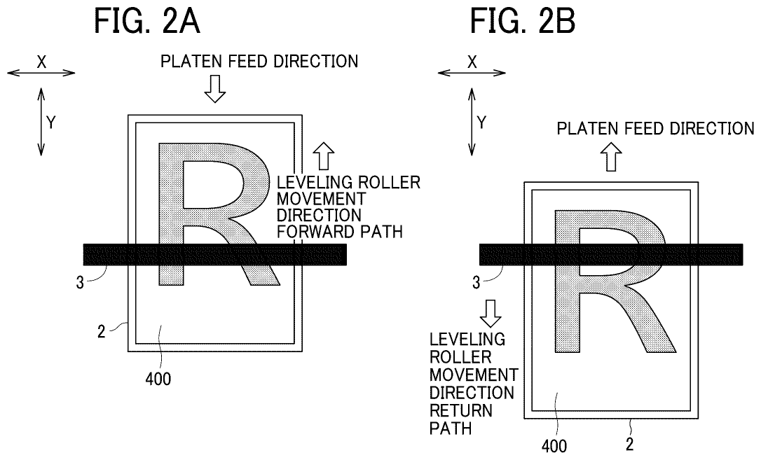

The leveling roller 3 is configured so as to be capable of separating from cloth (a cloth 400 in FIG. 2), which is an example of a woven fabric serving as a target printing medium, by swinging in an up-down direction. The platen 2 that supports the cloth is disposed below the leveling roller 3.

The cloth 400 in FIG. 2 is transported in a direction that is orthogonal to a main scanning direction X, which is a scanning movement direction of the carriage 11 having the plurality of heads, that is, in a sub-scanning direction Y. The printing device 1 is equipped with a device configuration that supports or holds the cloth 400 (hereinafter, also simply referred to as “fabric”) with the platen 2, and is referred to as having a so-called garment printer or textile printer device configuration.

The operator of the printing device 1 operates the printing device 1 facing the front, which is a downstream side of the platen 2 in the sub-scanning direction Y in FIG. 1A (the diagonally left-front side of the platen 2 in FIG. 1A). The platen 2 is configured so as to be movable in an up-down direction Z such that the distance (gap) between the nozzle surfaces of the heads 10 and the carriage 11 can be adjusted in order to handle target printing media ranging from relatively thin shirts (including T-shirts and the like) to relatively thick socks, cloth bags, and the like.

The target printing medium that has been attached and supported on the platen 2 moves from the diagonally right-rear side toward the diagonally left-front side in FIG. 1A according to the progress of a printing step.

The platen 2 is attached and mounted on a raising/lowering mechanism 41. The raising/lowering mechanism 41 is mounted on a slider 42. The height of the platen 2 in an up-down direction Z can be adjusted by the raising/lowering mechanism 41. The height of the platen 2 in the Z direction can be detected by a height detection sensor 27.

The slider 42 is installed so as to be movable on a slide rail 43 that extends in the sub-scanning direction Y, which is orthogonal to the main scanning direction X. The raising/lowering mechanism 41 includes an electric motor that is capable of rotating in forward and reverse directions, and is configured using, for example, a rack and pinion mechanism or a ball screw mechanism. The specific configurations other than the raising/lowering mechanism 41 of the platen 2 and the movement mechanism described below will be described in detail later.

In FIG. 1A, the main scanning direction X represents the direction in which the carriage 11 undergoes a reciprocating movement, Y represents the sub-scanning direction, which is orthogonal to the main scanning direction X, and Z represents the up-down direction (which is also a vertical direction or a height direction), which is orthogonal to both the main scanning direction X and the sub-scanning direction Y.

A pair of guide members 12 and 13 hold the carriage 11 so as to be capable of a reciprocating movement in the main scanning direction X. The carriage 11 is joined to a timing belt 17 that is passed around a drive pulley and a driven pulley that are rotated by a main scanning motor that can rotate in forward and reverse directions. The carriage 11 undergoes a reciprocating movement in the main scanning direction X as a result of driving the main scanning motor.

An encoder sheet provided with periodic slits is arranged along the main scanning direction X in FIG. 1A. The carriage 11 includes a reading sensor that reads the slits of the encoder sheet, and is configured such that the position of the carriage 11 in the main scanning direction X can be detected from the reading result of the reading sensor.

A controller board 50 illustrated in FIG. 1A controls the discharging of ink from the heads 10 according to a timing in which the ink, being a liquid, is to be discharged from a movement position of the carriage, which is obtained from the reading result of the reading sensor of the carriage 11, to a discharge position.

A total of six heads 10 are mounted on the carriage 11. Each head 10 has two nozzle arrays in which nozzles that discharge a liquid of a desired color are arranged.

The carriage 11 is mounted with subtanks that temporarily hold the ink to be supplied to the heads 10 as a liquid. The inks, being liquids of the desired colors, or a pretreatment liquid are delivered from the main tanks 21 provided on the device body side to the subtanks by a liquid delivery pump via a supply tube.

The carriage 11 is mounted with six heads 10 that discharge each of white (W), cyan (C), magenta (M), yellow (Y), and black (Bk) colored ink, and a pretreatment liquid. The head 10 of each color is provided with the two nozzle arrays arranged in parallel that include approximately 200 nozzles that discharge the ink.

The printing device 1 is provided with a position sensor, which serves as a height detection means that detects the height position of the platen 2 in the up-down direction Z. The position sensor includes, for example, an emission unit that emits laser light, and a light receiving unit that receives the laser light, and detects whether or not the surface of the cloth 400 on the platen 2 will interfere with the nozzle surfaces of the heads 10, and the like.

That is, the surface position of the cloth 400 on the platen 2 is determined by the position sensor based on whether or not the surface of the cloth 400 on the platen 2 blocks the laser light. If the surface of the cloth 400 on the platen 2 blocks the laser light, an error occurs and the platen 2 is controlled so as to stop.

The distance (gap) between the surface of the cloth 400 and the nozzle surfaces is preferably as narrow as possible, and is set so as to prevent contact when the raising/lowering mechanism 41 is operated. Specifically, the distance is set to about 0.5 to 7 mm. Although it is desirable to be able to set the distance between the cloth surface and the nozzle surfaces such that the distance is automatically determined and adjusted, a manually change may be possible to enable an adjustment to a height position at which an error does not occur.

The slider 42 undergoes a reciprocating movement in the sub-scanning direction Y by a sub-scanning drive mechanism via a timing belt 45. As a result of the reciprocating movement of the slider 42 in the sub-scanning direction Y, the platen 2 also undergoes a reciprocating movement in the sub-scanning direction Y.

A maintenance unit 60 that maintains and recovers the heads 10 is arranged on one end side in the main scanning direction X. The maintenance unit 60 includes a suction cap that caps the nozzle surfaces of the heads 10, a moisturizing cap that caps the nozzle surfaces of the heads 10 to maintain moisture, and a wiper that wipes the nozzle surfaces of the heads 10. A suction pump is connected to the suction cap 61.

A discharge receiver 66 is arranged on the other end side of the main scanning direction X. The controller board 50 maintains and recovers the heads 10 by discharging (dry blowing) liquid from the heads 10 to the discharge receiver 66 during the printing step.

Furthermore, the printing device 1 includes a power button 70 for connecting and disconnecting the electrical power supplied to the printing device 1, an operation unit 71 for issuing instructions and operating each unit of the printing device 1, a power supply unit 72 that supplies electrical power to each unit of the printing device 1, and the like.

### Printing Operation

The series of printing operations of the printing device 1 will be described taking an example of a case where a cloth, which is a woven fabric, is printed as the target printing medium. It is preferable that the cloth 400 (illustrated in FIG. 2), which is an example of a woven fabric, has a pretreatment liquid coated on the printing surface of the cloth 400 before being printed by the printing device 1. This is because, if pretreatment is not performed by coating a pretreatment liquid, the ink used in the present embodiment may enter the joints of the cloth 400, making it difficult to obtain the target image.

As the pretreatment liquid, a liquid may be used that contains a flocculant (for example, a cationic metal) for electrically binding, aggregating, and fixing to the surface a pigment (solid: anionic), which is a colorant. In a conventional process of coating a pretreatment liquid using a roller or a spray, because the pretreatment liquid is coated in a separate step to the image formation by the printing device, the position in which the image will be printed on the fabric is not known. Even if the position is known, if an offset occurs in the position in which the fabric is set in the pretreatment step and the image printing step, there is a possibility that a part in which pretreatment has not been applied may occur under the printed image. Therefore, in the conventional process, the pretreatment liquid is coated over a wide area such that problems do not occur, regardless of where the image is printed. Of course, those locations where an image is not printed result in a coating that is wasted.

By contrast, in the printing device of the present embodiment, in which coating of the pretreatment liquid is performed by inkjet head discharge, the platen on which the fabric is set is the same during pretreatment, white ink printing, and color printing, and no attachment offset occurs. Because pretreatment liquid discharge data is created under the same control as the white/colored ink printing, it is possible to accurately (digitally) discharge a preferable amount in a preferable location. In addition, in the printing device of the present embodiment, by performing the leveling step with the leveling roller member 3 after forming the pretreatment liquid image, it is possible to uniformly permeate the pretreatment liquid into the printing region of the medium. Furthermore, although fluffing and the like often occurs in media such as woven fabrics, the leveling step can also have the effect of smoothing out the fluffing.

When printing is performed on the cloth 400, such as a T-shirt, the cloth 400 is supported and set on the platen 2. After a series of operations before printing, the cloth 400 is supported and set by being attached to the platen 2 to prevent wrinkles (unevenness). Then, by operating the operation unit 71, a motion is performed that completely pulls in the platen 2 toward the rear (the upstream side in the sub-scanning direction Y) inside the device body via the slider 42.

Then, the platen 2 that is supporting the cloth 400 moves to a printing start position (the downstream side in the sub-scanning direction Y in FIG. 1A). At this time, the height is detected by the position sensor such that the upper surface of the cloth 400 on the platen 2 does not make contact with the nozzle surfaces of the heads 10. Further, the height position of the platen 2 is adjusted via the raising/lowering mechanism 41 such that the distance (gap) between the upper surface of the cloth 400 and the nozzle surfaces of the heads 10 is maintained within the predetermined range.

At this time, when interference or a collision occurs between the heads 10 and the cloth 400, the platen 2 is stopped from being drawn in, or the platen 2 is returned to the position at which the cloth 400 was set. When the platen 2 passes the position sensor without an error, the platen 2 moves to a first writing position of the printing device 1.

A printing data standby state occurs after the platen 2 has been drawn in. Here, a printing operation check is performed when the printing device 1 receives printing data from an external information processing device (for example, a computer such as a personal computer, or a smartphone), and then the printing operation is started. Alternatively, if the printing data is stored in advance on the controller board 50, the printing operation is started by selecting the printing data with the operation unit 71.

When the printing operation is started, the platen 2 is moved to a printing start position via the slider 42. Then, the carriage 11 reads the encoder sheet along the main scanning direction X, and moves in the main scanning direction X while being guided by the first and second guide members 12 and 13. Further, ink is discharged by the heads 10 onto the surface of the cloth 400 that has been set on the platen 2.

The printing is performed while the platen 2 moves in the sub-scanning direction Y (from the upstream side at the rear to the downstream side at the front) on the first and second guide members 12 and 13 according to the motion of the heads 10. In this way, the movement of the carriage 11 and the discharge of the ink or pretreatment liquid from the heads 10 is performed, and one row is printed.

When one row is printed, the platen 2 moves by one row via the slider 42. As a result of repeating the single scans of the carriage 11 and the intermittent movement of the slider 42, the printing is performed in the desired region on the surface of the cloth 400.

After the printing is completed, the platen 2 is returned to the downstream side (the front of the device body) in the sub-scanning direction Y, and the printing ends. After the printing ends, the cloth 400 is removed from the platen 2, and posttreatment operations such as heating and fixing are performed using a heat press machine or the like, and the series of operations and work performed by the printing device 1 ends.

Note that it is preferable to use caution when printing on cloth other than white cloth. That is, if the printing is performed normally, the color tone changes due to the influence of the base color of the cloth. A pretreatment liquid is firstly coated to prevent such an effect. Then, after performing the leveling step with the leveling member, a white coating is printed over the entire printing area of the cloth.

Then, the carriage 11 is moved once again to the printing start position, and the desired image is printed with the remaining four colors. That is, the printing is overlapped three times.

Hereinafter, the printing method of the present embodiment that is performed by the printing device 1 will be described by way of a plurality of Examples 1 to 10.

### Example 1

The motion of the leveling roller 3 in the printing device 1 of FIGS. 1A and 1B is illustrated in FIGS. 2A and 2B. It is possible to perform the leveling step in the sub-scanning direction Y by scanning the platen 2 in the Y direction in a state where the leveling roller 3 is making contact with the upper surface of the platen 2. As illustrated in FIGS. 2A and B, the leveling roller 3 is capable of leveling roller application (leveling roller movement) in both directions in the Y direction.

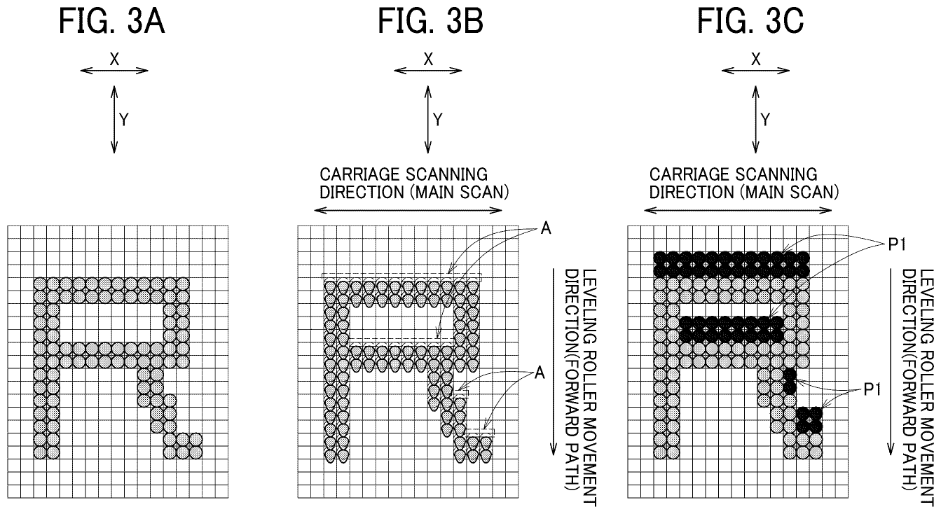

As a result of discharging the pretreatment liquid onto a pattern part, as illustrated in FIG. 3A, a normal pretreatment liquid image is formed. Furthermore, the change in shape of the pretreatment liquid image after the leveling roller movement in one direction with respect to the pretreatment liquid image in FIG. 3A, which is represented by the arrow in FIG. 2B, is illustrated in FIG. 3B.

Because the pretreatment liquid that has soaked into the fabric is spread in the leveling roller movement direction, the pretreatment liquid image is offset in the leveling roller movement direction. In particular, an insufficient amount of the pretreatment liquid occurs in the pixels on the upstream side in the leveling roller movement direction (a dashed line portion A in FIG. 3B). Therefore, when a colored ink image is formed on the pretreatment liquid image in FIG. 3B, a reduction in image quality (edge portion sharpness) occurs due to the insufficient amount of the pretreatment liquid in the dashed line portion A.

Therefore, a pretreatment liquid image forming method according to the present example is performed as illustrated in FIG. 3C. A feature of FIG. 3C is that, in addition to the pattern part in FIG. 3A, the pretreatment liquid is discharged in an extended area on the upstream side of the direction in which the leveling roller 3 is applied. The pretreatment liquid that is discharged in the extended area is indicated by large black circles P1 in FIG. 3C. The part represented by the large black circles P1 is referred to as an “overhang region” below.

Even if the pretreatment liquid that has soaked into the fabric is spread by the leveling roller 3, it is possible to replenish the amount of the pretreatment liquid by using the pretreatment liquid in the overhang region that has been discharged in the extended area as indicated by the large black circles P1. As a result, it is possible to prevent a reduction in the image quality (edge portion sharpness) due to an insufficient amount of the pretreatment liquid as illustrated in FIG. 3B.

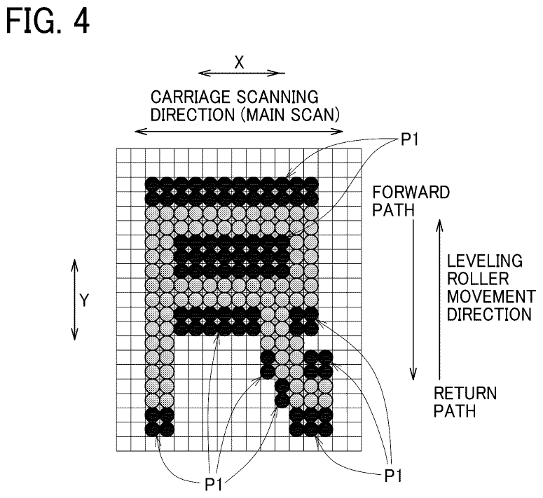

Furthermore, a pretreatment liquid image forming method when the leveling roller 3 is moved in both directions in the sub-scanning direction Y is illustrated in FIG. 4. The pretreatment liquid that is discharged in an extended area is indicated by the black circles P1 in FIG. 4. Because the pretreatment liquid that has soaked into the fabric is spread not just in the forward direction of the leveling roller 3, but also in the return direction, the region in which the pretreatment liquid is discharged is expanded in both directions.

Here, the insufficient amount of the pretreatment liquid caused by the leveling step is covered by a method of increasing the number of pixels in which the pretreatment liquid is discharged. However, the present embodiment is not limited to such a method.

It is also possible to cover an insufficient amount of the pretreatment liquid by a method of enlarging the dot size of the pretreatment liquid that is discharged in the pixels, or repeatedly discharging the pretreatment liquid in the same pixels. A reduction in the image quality (edge portion sharpness) can similarly be prevented by such a method.

In a conventional technique, the pretreatment liquid image is discharged slightly more broadly than the colored ink image in consideration of a landing position offset of the pretreatment liquid and the colored ink caused by head and discharge variations. However, the change in shape of the pretreatment liquid image caused by the leveling motion, that is, the position offset due to the pretreatment liquid that has soaked into the fabric being spread in the leveling roller movement direction, can sometimes be larger than the landing position offset caused by head and discharge variations.

As a result, a pretreatment liquid discharge method such as that of the conventional technique cannot solve the problem that a reduction in the edge portion sharpness of an image occurs. Therefore, by discharging the pretreatment liquid more broadly by expanding the area on the upstream side of the leveling roller movement direction as described in the present embodiment, a reduction in the edge portion sharpness of an image can be prevented.

### Example 2

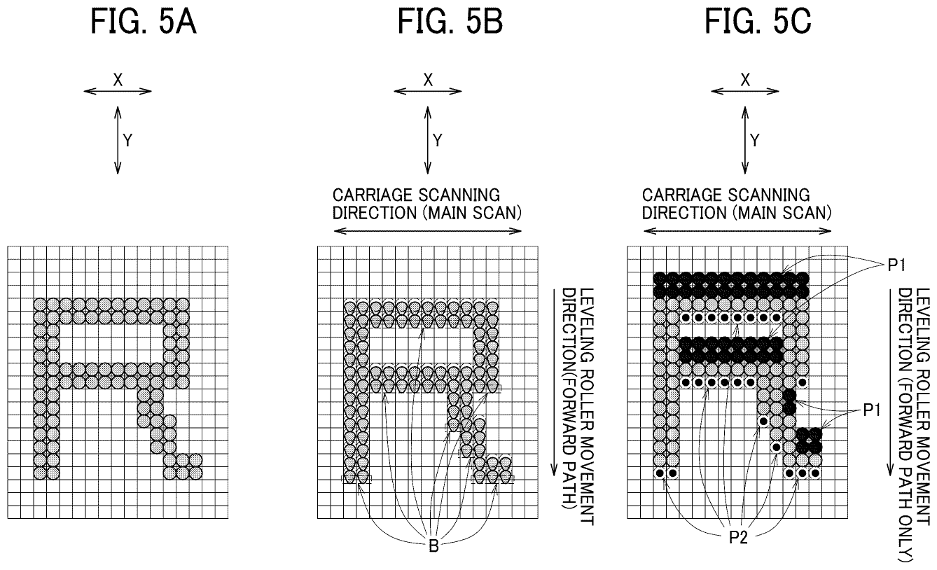

A case will be considered in which the leveling roller is moved in only one of the directions in the printing device 1 in FIG. 1A. When the leveling roller is moved in only one of the directions with respect to the discharge pattern of a normal pretreatment liquid image illustrated in FIG. 5A, as illustrated in FIG. 5B, the pretreatment liquid that has soaked into the fabric is spread in the leveling roller movement direction.

In particular, the pretreatment liquid seeps outside the colored ink image area at a dashed line portion B in FIG. 5B.

When the colored ink image is formed with the pretreatment liquid having seeped outside the colored ink image area of the target printing medium as illustrated in FIG. 5B, and heat and pressure fixing is then performed in a posttreatment operation using a heat press machine or the like, the pretreatment liquid can sometimes turn white and produce an abnormal image.

Therefore, in a pretreatment liquid image forming method of the present embodiment, the pretreatment liquid is discharged as illustrated in FIG. 5C.

That is, the discharge of the pretreatment liquid is reduced on the downstream side of the leveling roller movement direction. The discharge of the pretreatment liquid that has been reduced is indicated by small black circles P2 in FIG. 5C.

It is possible to suppress seepage of the pretreatment liquid by reducing the number of pixels in which the pretreatment liquid is discharged on the downstream side in the leveling roller movement direction, or by reducing the dot size. A printing method has been proposed in which the pretreatment liquid is discharged in a smaller area than the printing region in order to prevent the pretreatment liquid from seeping out.

However, such a printing method does not consider the change in shape of the pretreatment liquid image due to the leveling step. Therefore, it is not possible to solve the problem of the pretreatment liquid seeping out due to the leveling step. In the present embodiment, it is possible to suppress seepage of the pretreatment liquid as a result of reducing the pretreatment liquid discharged on the downstream side of the leveling roller movement direction.

### Example 3

When the direction in which the leveling roller movement is performed is only one direction as illustrated in FIG. 5C, as described above in Examples 1 and 2, it is possible to both discharge the pretreatment liquid more broadly by expanding the area on the upstream side of the leveling roller movement direction (the pretreatment liquid represented by the large black circles P1 in FIG. 5C), and reducing the pretreatment liquid discharged on the downstream side of the roller application direction (the pretreatment liquid represented by the small black circles P2 in FIG. 5C).

### Example 4

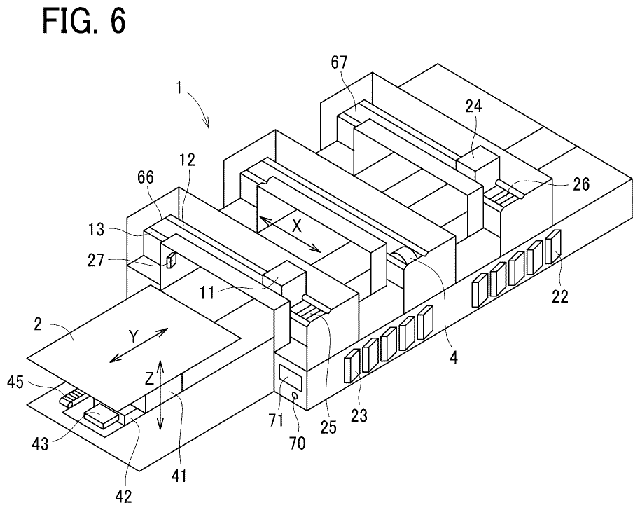

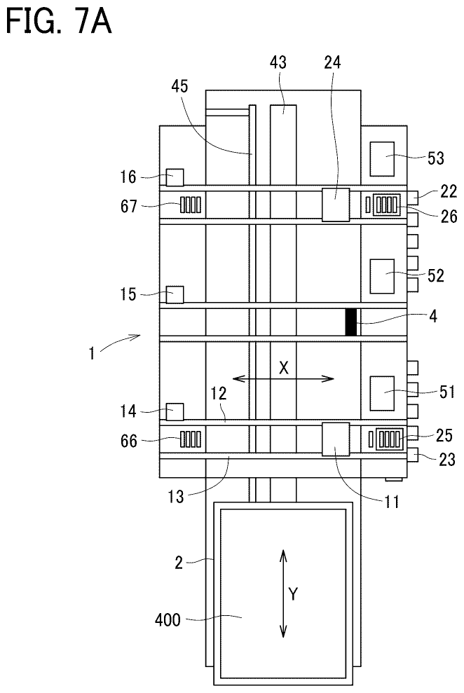

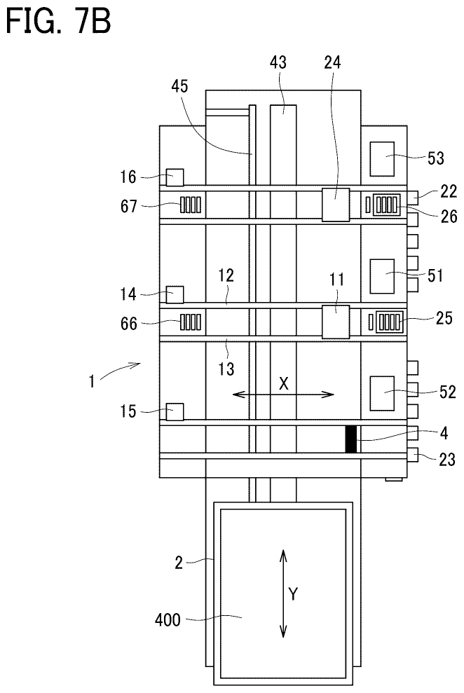

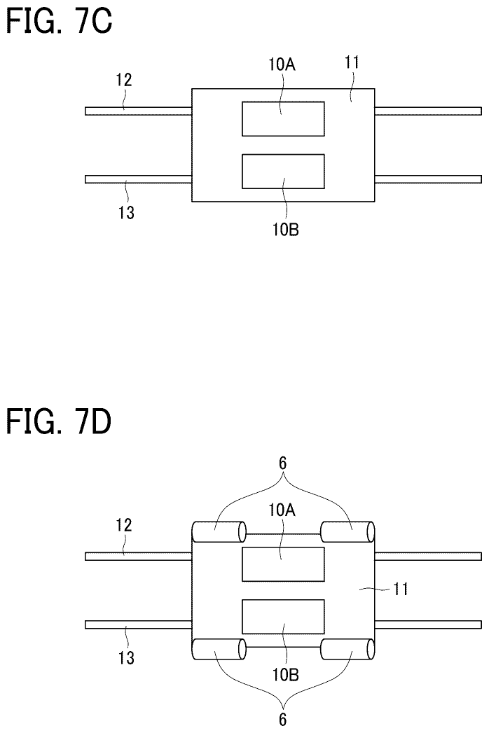

A perspective view of a printing device 1 including a leveling roller 4 that moves in the main scanning direction X is illustrated in FIG. 6, and a top view is illustrated in FIG. 7A. This printing device 1 uses the leveling roller 4 instead of the leveling roller 3 of the printing device 1 in FIG. 1A. The leveling motion in the main scanning direction X is performed by the leveling roller 4.

The printing device 1 in FIGS. 6 and 7A is configured such that a colored ink carriage 11, the leveling roller 4, and a pretreatment liquid carriage 24 are capable of moving in the main scanning direction X by separate main scanning motors 14, 15 and 16, respectively. In order to independently control each of the main scanning motors 14, 15 and 16, controller boards 51, 52 and 53 are also separately arranged, respectively.

The colored ink carriage 11 is configured such that the function is maintained by a maintenance mechanism (maintenance unit) 25. The pretreatment liquid carriage 24 is configured such that the function is maintained by a maintenance mechanism (maintenance unit) 26.

Furthermore, discharge receivers 66 and 67 for dummy discharge the carriages 11 and 24 are arranged on one side (the left side) in FIG. 7A. Pretreatment liquid cartridges 22 and colored ink cartridges 23 are arranged on the other side (the right side) in FIG. 7A. The rest of the configuration is the same as the printing device 1 in FIG. 1A.

FIG. 7B is a top view of the printing device 1, in which the leveling roller 4 in FIG. 7A is arranged on the front side of the device, while the carriage 11 is arranged in the center of the device. In this way, it is possible to interchangeably arrange the carriage 11 and the leveling roller 4 in the front and rear.

FIG. 7C is a top view of a carriage 11 provided with a plurality of liquid discharge heads 10A and 10B. For example, the pretreatment liquid can be discharged from the liquid discharge head 10A on the rear side of the device. Further, for example, white ink or colored ink can be discharged from the liquid discharge head 10B on the front side of the device. As a result of using the carriage 11 in FIG. 7C, it is possible to omit the pretreatment liquid carriage 24 and the main scanning motor 16 and the like illustrated in FIGS. 7A and 7B, and it is possible to significantly reduce the size and lower the cost of the printing device 1.

FIG. 7D is a top view of a carriage 11 provided with a plurality of leveling rollers 6 in addition to the plurality of liquid discharge heads 10A and 10B in FIG. 7C. It is possible to replace the carriage 11 of the printing device 1 in FIGS. 7A and 7B with this carriage 11. In this case, it is possible to significantly reduce the size and lower the cost of the printing device 1 by omitting the leveling roller 4.

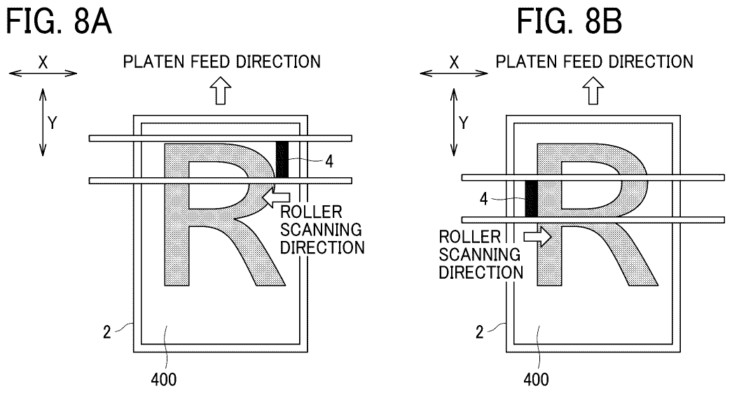

The leveling motion in the main scanning direction X is illustrated in FIGS. 8A and 8B. It is possible to perform the leveling step by scanning the platen 2 in the sub-scanning direction Y while also causing the leveling roller 4 to undergo reciprocating scanning in the main scanning direction X on the platen 2.

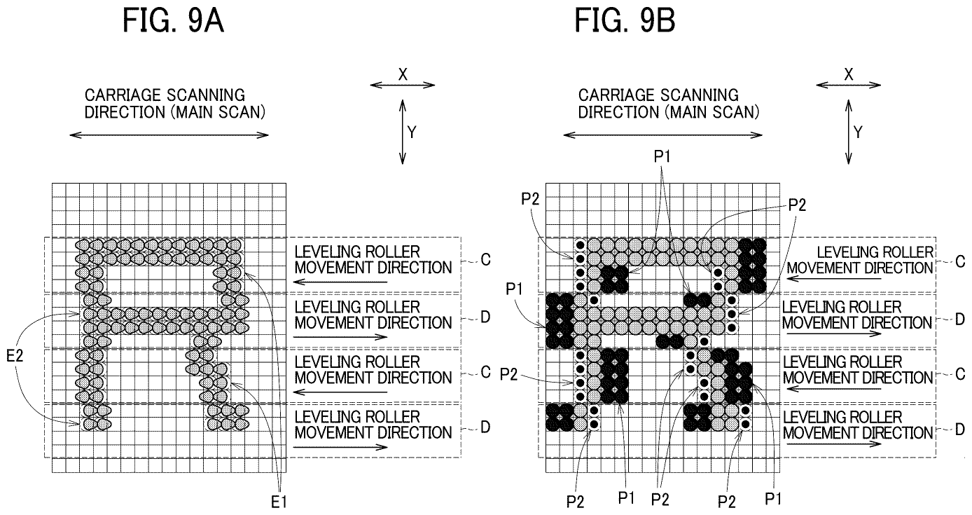

A pretreatment liquid image pattern obtained when a leveling roller movement is performed in both directions in the main scanning direction X in the printing device 1 illustrated in FIGS. 6, 7A, and 7B without an overlap in the leveled region is illustrated in FIGS. 9A and 9B. FIG. 9A illustrates the change in shape of the pretreatment liquid image after moving the leveling roller 4 with respect to the normal pretreatment liquid image illustrated in FIG. 3A. The dashed line portion C is a region in which the leveling roller 4 has moved on the forward path, and the dashed line portion D is a region in which the leveling roller 4 has moved on the return path.

At this time, the pretreatment liquid that has soaked into the fabric is spread in the same direction as the movement direction of the leveling roller 4. In particular, there is an insufficient amount of the pretreatment liquid in the pixels of leveling direction upstream edge portions E1 and E2 in FIG. 9A.

Therefore, in the present embodiment, the pretreatment liquid image is formed as illustrated in FIG. 9B. When comparing the parts with the dashed line portions C or D, the pretreatment liquid image in FIG. 9B corresponds to the pretreatment liquid image of a case where the leveling roller 3 moves in the sub-scanning direction Y as illustrated in FIG. 5C.

That is, when the leveling roller movement is performed in both directions without an overlap in the leveled regions, it is possible to discharge the pretreatment liquid more broadly by expanding the area on the upstream side of the roller application direction as indicated by the large black circles P1 in FIG. 9B, and further, it is possible to reduce the pretreatment liquid discharged on the downstream side of the roller application direction as indicated by the small black circles P2 in FIG. 9B.

### Example 5

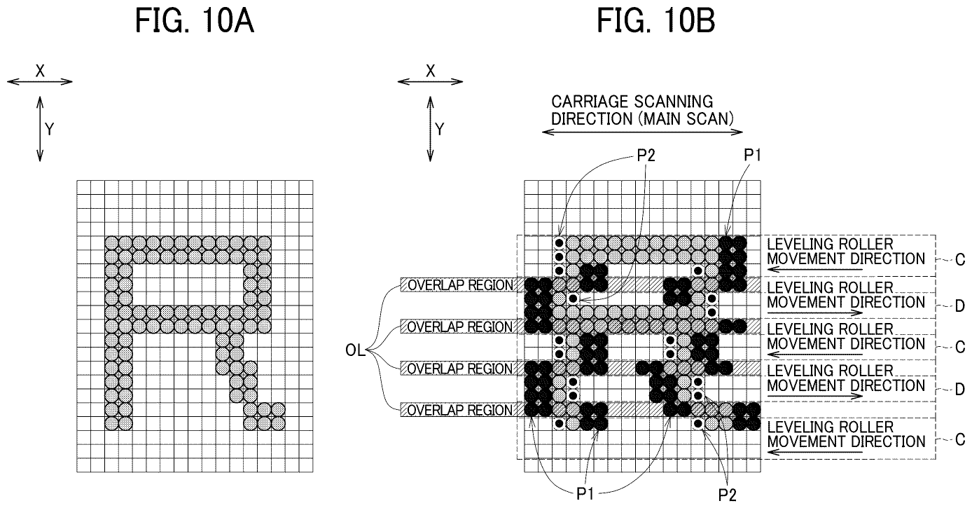

FIGS. 10A and 10B illustrate a case where the leveled regions overlap in at least a portion of the region (one pixel row in the adjacent part between the dashed line portions C and D). The dashed line portion C in FIG. 10B is the region in which the leveling roller 4 moves on the forward path, and the dashed line portion D is the region in which leveling roller 4 moves on the return path.

When the leveled regions do not overlap as in FIGS. 9A and 9B, the pretreatment liquid is discharged in an expanded area on the upstream side of the leveling roller movement direction (large black circles P1), and is reduced on the downstream side (small black circles P2). By contrast, when a portion of the leveled regions overlap in an overlapped region OL, the pretreatment liquid is discharged in an expanded region in both the forward path and return path directions of the leveling roller 4.

As a result, even when the overlapped region OL exists, it is possible to discharge the pretreatment liquid more broadly by expanding the area on the upstream side of the roller application direction as indicated by the large black circles P1 in FIG. 10B. Further, it is possible to reduce the pretreatment liquid discharged on the downstream side of the roller application direction as indicated by the small black circles P2 in FIG. 10B.

### Example 6

The roller pressure of the leveling rollers 3 and 4 may be changed depending on the type of the fabric and the like. In this case, the more the pressure the leveling rollers 3 and 4 apply to the fabric increases, the more the pretreatment liquid that has soaked into the fabric is spread in the roller movement direction.

As a result, the more the pressure the leveling rollers 3 and 4 apply to the fabric increases, the more the amount of the pretreatment liquid that is discharged on the upstream side of the roller application direction is increased, and the amount of the pretreatment liquid that is discharged on the downstream side is reduced. In this way, the discharged amount of the pretreatment liquid is adjusted depending on the pressure the leveling rollers 3 and 4 apply to the fabric.

In other words, when an application density of a pretreatment liquid in the overhang region on an upstream side of a planned formation region of the printing liquid image when the leveling rollers 3 and 4 are moved at a predetermined pressure P with respect to the pretreatment liquid image is denoted by Da, and an application density of a pretreatment liquid applied to a downstream edge portion of a planned formation region of the printing liquid image is denoted by Db, Da is increased and Db is decreased as the predetermined pressure P increases, and Da is decreased and Db is increased as the predetermined pressure P decreases. As a result, a reduction in the image quality (edge portion sharpness) can be prevented, regardless of the pressure P of the leveling rollers 3 and 4.

Here, the application densities Da and Db are, 1) the amount of the pretreatment liquid applied per area of one pixel of the image, or 2) the amount of the pretreatment liquid applied per area of a plurality of pixels of the image.

Here, the “area of a plurality of pixels” is the area of a plurality of consecutive pixels in a single column in the movement direction of the leveling roller 3 and 4.

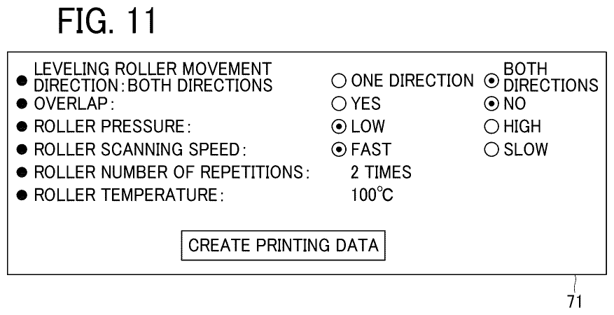

The strength of the roller pressure can be set using the operation unit 71. FIG. 11 is a display example of the operation unit 71. After setting each item, including the roller pressure, the printing data as in FIGS. 3C, 5C, 9B, and 10B is created by touching a “create printing data” button.

### Example 7

The scanning speed of the leveling rollers 3 and 4 may be changed depending on the type of the fabric and the like. The roller scanning speed can be set using the operation unit 71 in FIG. 11.

In this case, the faster the scanning speed (leveling speed) of the leveling rollers 3 and 4, the more the pretreatment liquid that has soaked into the fabric is spread in the roller movement direction. Therefore, the more the scanning speed of the leveling rollers 3 and 4 is increased, the more the amount of the pretreatment liquid that is discharged on the upstream side of the roller application direction is increased, and the amount of the pretreatment liquid that is discharged on the downstream side is reduced. In this way, the discharge amount of the pretreatment liquid is adjusted according to the scanning speed (leveling speed) of the leveling rollers 3 and 4.

In other words, when an application density of a pretreatment liquid in the overhang region on an upstream side of a planned formation region of the printing liquid image when the leveling rollers 3 and 4 are moved at a predetermined speed V with respect to the pretreatment liquid image is denoted by Da, and an application density of a pretreatment liquid applied to a downstream edge portion of a planned formation region of the printing liquid image is denoted by Db, Da is increased and Db is decreased as the predetermined speed V increases, and Da is decreased and Db is increased as the predetermined speed V decreases. As a result, a reduction in the image quality (edge portion sharpness) can be prevented, regardless of the scanning speed (leveling speed) of the leveling rollers 3 and 4. Here, the application densities Da and Db are the amount of the pretreatment liquid applied per dot area of the image.

### Example 8

The number of repeated scans performed by the leveling rollers 3 and 4 may be changed depending on the type of the fabric and the like. The number of repeated scans performed by the roller can be set using the operation unit 71 in FIG. 11.

In this case, the greater the number of repeated scans performed by the leveling rollers 3 and 4, the more the pretreatment liquid that has soaked into the fabric is spread in the roller movement direction. Therefore, the greater the number of repeated scans performed by the leveling rollers 3 and 4, the more the amount of the pretreatment liquid that is discharged on the upstream side of the roller application direction is increased, and the amount of the pretreatment liquid that is discharged on the downstream side is reduced. As a result, the discharge amount of the pretreatment liquid can be adjusted according to the number of repeated scans performed by the leveling rollers 3 and 4.

In other words, when an application density of a pretreatment liquid in the overhang region on an upstream side of a planned formation region of the printing liquid image when the leveling rollers 3 and 4 are moved with a predetermined number of repeated scans N with respect to the pretreatment liquid image is denoted by Da, and an application density of a pretreatment liquid applied to a downstream edge portion of a planned formation region of the printing liquid image is denoted by Db, Da is increased and Db is decreased as the predetermined number of repeated scans N increases, and Da is decreased and Db is increased as the predetermined number of repeated scans N decreases. As a result, a reduction in the image quality (edge portion sharpness) can be prevented, regardless of the number of repeated scans performed by the leveling rollers 3 and 4. Here, the application densities Da and Db are the amount of the pretreatment liquid applied per dot area of the image.

### Example 9

The temperature of the leveling rollers 3 and 4 may be changed depending on the type of the fabric and the like. The roller temperature can be set using the operation unit 71 in FIG. 11.

In this case, the more the temperature of the leveling rollers 3 and 4 increases, the easier it becomes for the pretreatment liquid that has soaked into the fabric to become dried, and the more difficult it becomes for the pretreatment liquid image to be spread in the roller movement direction. Therefore, the higher the temperature of the leveling roller, the more the amount of the pretreatment liquid that is discharged on the upstream side of the roller application direction is decreased, and the amount of the pretreatment liquid that is discharged on the downstream side is increased. As a result, the discharge amount of the pretreatment liquid can be adjusted according to the temperature of the leveling rollers 3 and 4.

In other words, when an application density of a pretreatment liquid in the overhang region on an upstream side of a planned formation region of the printing liquid image when the leveling rollers 3 and 4 are moved at a predetermined temperature T with respect to the pretreatment liquid image is denoted by Da, and an application density of a pretreatment liquid applied to a downstream edge portion of a planned formation region of the printing liquid image is denoted by Db, Da is decreased and Db is increased as the predetermined temperature T increases, and Da is increased and Db is decreased as the predetermined temperature T decreases. As a result, a reduction in the image quality (edge portion sharpness) can be prevented, regardless of the temperature of the leveling rollers 3 and 4. Here, the application densities Da and Db are the amount of the pretreatment liquid applied per dot area of the image.

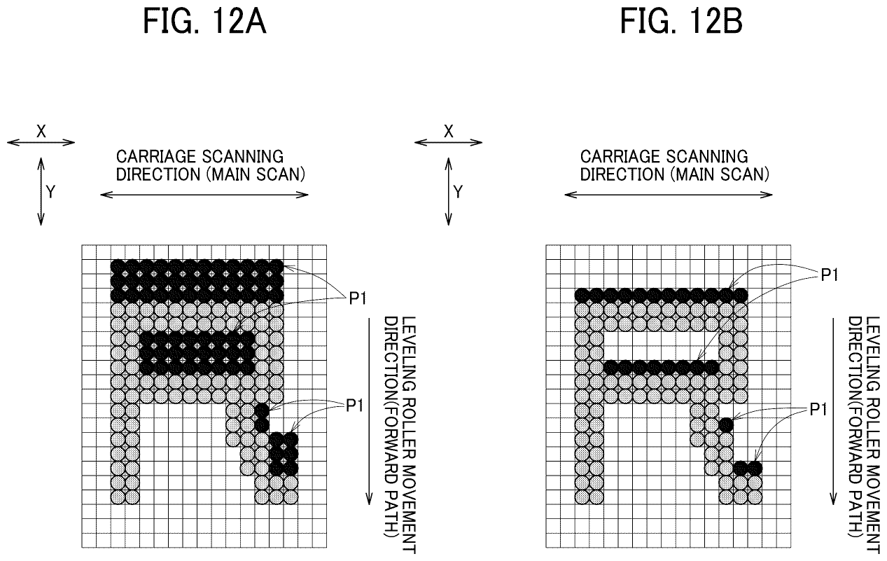

FIGS. 12A and 12B are diagrams illustrating pretreatment liquid images when the leveling roller application conditions are changed from those in Examples 6 to 9. FIG. 12A is a pretreatment liquid image obtained under conditions in which the pretreatment liquid is easily spread, that is, when 1) the pressure is high, 2) the scanning speed is fast, 3) the number of repeated scans is large, and 4) the temperature is low.

The overhang region on the upstream side of the leveling roller movement direction has the pretreatment liquid discharged in a large region, as indicated by the large black circles P1. As a result, it is possible to prevent a reduction in the image quality (edge portion sharpness) due to an insufficient amount of the pretreatment liquid as illustrated in FIG. 3B.

FIG. 12B is a pretreatment liquid image obtained under conditions in which it is difficult for the pretreatment liquid to be spread, that is, when 1) the pressure is low, 2) the scanning speed is slow, 3) the number of repeated scans is small, and 4) the temperature is high. The overhang region on the upstream side of the leveling roller movement direction has the pretreatment liquid discharged in a smaller region than in FIG. 12A, as indicated by the large black circles P1. As a result, it is possible to prevent a reduction in the image quality (edge portion sharpness) due to an insufficient amount of the pretreatment liquid as illustrated in FIG. 3B.

In FIG. 12B, because it is more difficult for the pretreatment liquid to be spread, when the pretreatment liquid is discharged in a large area as illustrated in FIG. 12A, the pretreatment liquid tends to remain on the upstream side of the printing image. This residual pretreatment liquid can sometimes remain as pretreatment marks and stand out after the printing image is fixed to the fabric by a heat press or the like.

Therefore, when conditions are used in which it is difficult for the pretreatment liquid to be spread, the pretreatment liquid is discharged in a smaller area as illustrated in FIG. 12B. As a result, it is possible to prevent the occurrence of pretreatment marks.

### Example 10

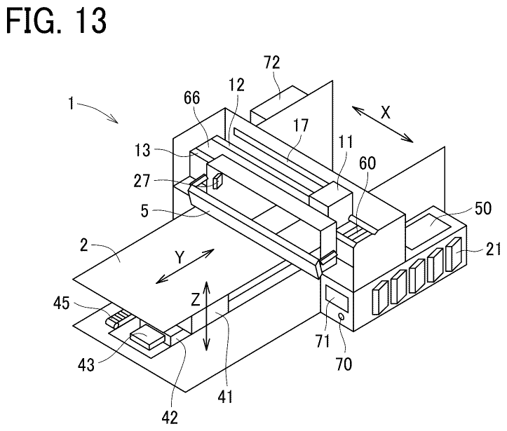

FIG. 13 is a printing device 1 including a leveling squeegee 5 as a leveling member. The printing device 1 levels the fabric surface using the leveling squeegee 5 instead of the leveling roller 3 in FIG. 1A. The leveling squeegee 5 may also be a leveling blade. It is similarly possible to improve the edge portion sharpness after the leveling step and prevent seepage of the pretreatment liquid using the leveling squeegee 5 or the leveling blade.

### Example 11

The permeability of the pretreatment liquid with respect to the target printing medium (fabric) differs depending on the type of medium. The pretreatment liquid permeates more easily into a medium having a high liquid absorptivity. Therefore, in a medium with a high liquid absorptivity, the amount of reactive components such as the flocculant in the pretreatment liquid remaining on the medium may become small, which may cause a reduction in image quality.

Therefore, a technique has been proposed that stabilizes the permeability and wet spreadability of the pretreatment liquid irrespective of the type of medium by using a plurality of pretreatment liquids having different permeability and changing the order in which the plurality of pretreatment liquids are coated according to the type of medium. In such a technique using a plurality of pretreatment liquids, the “offset” occurs in the leveling step, that is, the “offset” occurs between the pretreatment liquid and the colored ink. By contrast, in Example 11 and 12, a reduction in image quality (edge portion sharpness) caused by such an offset is prevented.

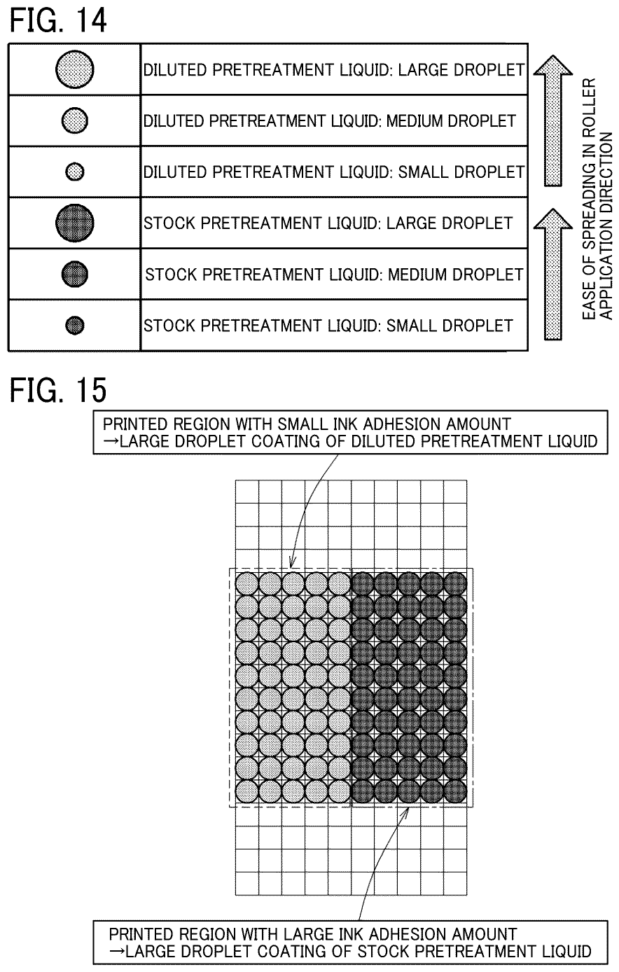

FIG. 14 illustrates a list of droplet types of the two types of pretreatment liquids installed in the printing device (the printing device 1 in FIGS. 1A, 6, 7A, and 7B) used in Examples 11 and 12 of the present embodiment. The two types of pretreatment liquids are a “stock pretreatment liquid” and a “diluted pretreatment liquid”. The two types of pretreatment liquids are capable of being spotted (landing) on the medium as large droplets, medium droplets, and small droplets, respectively. The spotting diameter of the pretreatment liquid is in the order: large droplets>medium droplets>small droplets.

The reasons for installing the two types of pretreatment liquids are the three points below.
(1) In order to prevent a landing position offset between the ink and the pretreatment liquid, it is preferable for the pretreatment liquid to be spotted as large droplets having a high coverage rate for all pixels in which the ink will be landing.
(2) When all pixels are spotted using only large droplets of the stock pretreatment liquid, more aggregated ink components remain on the surface of the woven fabric. Although it is advantageous in terms of the color development of the ink if the amount of aggregated ink components is large, it becomes difficult for the ink to interact with the woven fabric when the ink adhesion amount is small, and the washing robustness decreases (the area in which the ink makes contact with the fabric becomes small).
(3) When the diluted pretreatment liquid is spotted only as large droplets, the aggregated ink component that remains on the surface of the woven fabric is small compared to the stock pretreatment liquid. Therefore, it becomes easier for the ink to interact with the woven fabric even when the ink adhesion amount is small, and the washing robustness improves.

FIG. 15 illustrates a normal (conventional) pretreatment liquid coating pattern in which a large droplet coating of two types of pretreatment liquids are divided into two columns according to the ink adhesion amount. The dashed line frame of the column on the left side is the printing region having a lower ink adhesion amount (the pixels in the fifth to fourteenth rows, and the first to fifth columns).

The diluted pretreatment liquid is coated as a large droplet coating in the region on the left side. On the other hand, the single-dot chain line frame of the columns on the right side is the printing region having a larger ink adhesion amount (the pixels in the fifth to fourteenth rows, and the sixth to tenth columns). The stock pretreatment liquid is coated as a large droplet coating in the region on the right side. It is assumed that the colored ink is spotted on the pixels in which the pretreatment liquid has been coated (the pixels in the fifth to fourteenth rows, and the first to tenth columns).

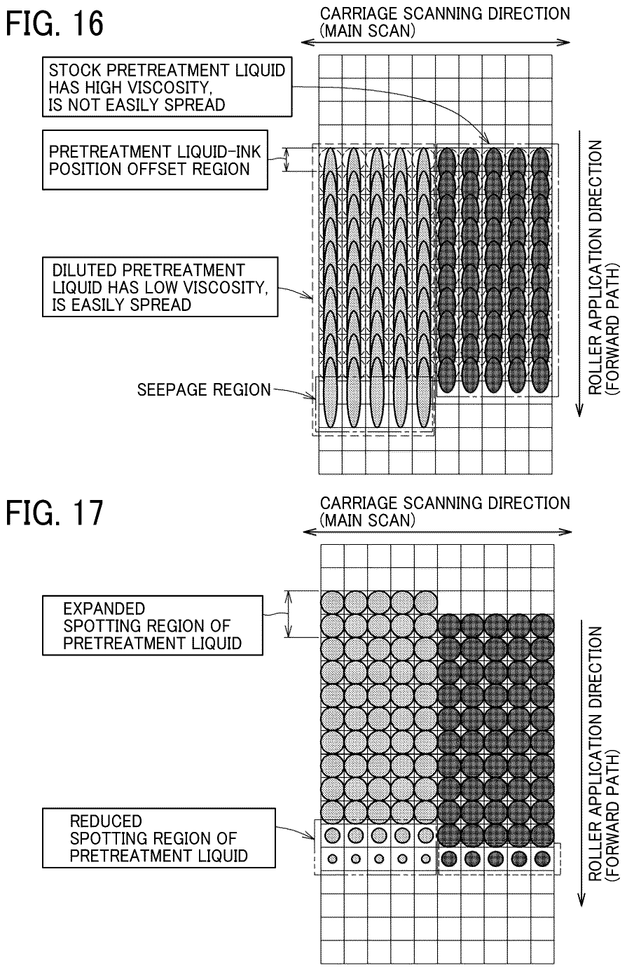

The leveling roller application is performed with respect to the pretreatment liquid coating pattern illustrated in FIG. 15 in a downward direction from the top. The pretreatment liquid pattern that has been spread after performing the leveling roller application is illustrated in FIG. 16. The two types of pretreatment liquids are each spread in the sliding direction (roller application direction) of the leveling roller.

As a result, a position offset region occurs between the pretreatment liquid and the ink on the upstream side of the roller application. The position offset region is the fifth row and the first to fifth columns for the diluted pretreatment liquid, and the fifth row and the sixth to tenth columns for the stock pretreatment liquid. The position offset is more significant for the fifth row and the first to fifth columns of the diluted pretreatment liquid because the pretreatment liquid is more easily spread.

Furthermore, a seepage region (two-dot chain line frame) occurs on the downstream side of the roller application. The seepage region is the fifteenth to sixteenth row and the first to fifth columns for the diluted pretreatment liquid, and the fifteenth row and the sixth to tenth columns for the stock pretreatment liquid.

In the other pixels (the sixth to fourteenth rows, and the first to tenth columns), because the pretreatment liquid component can be replenished by spreading the pretreatment liquid that has been spotted one row above, insufficient color development due to a landing position offset between the pretreatment liquid and the ink does not occur. For example, the pretreatment liquid that has been spotted on the pixel in the seventh row and the third column can have the pretreatment liquid component replenished from the pretreatment liquid in the sixth row and the third column.

Consequently, a decrease in the edge portion sharpness corresponding to the sliding direction of the roller occurs on the upstream side of the sliding direction of the leveling roller.

A decrease in the edge portion sharpness occurs at the pretreatment liquid-ink position offset region. Furthermore, abnormal images such as discolorations occur due to the pretreatment liquid that has seeped out to the seepage region.

The extent of the pretreatment liquid-ink position offset region and the seepage region (two-dot chain line) depends on the difference in the viscosities of each pretreatment liquid (the left column and the right column). This is because the amount of displacement when spread is different depending on the difference in the viscosities of each pretreatment liquid.

The diluted pretreatment liquid in the left column in FIG. 16 has a position offset region and a seepage region that are long in the downstream direction of the roller application. By contrast, the stock pretreatment liquid in the right column in FIG. 16 has a position offset region and a seepage region that are short in the downstream direction of the roller application.

Therefore, in Example 11, the pretreatment liquid coating pattern is improved as illustrated in FIG. 17 with consideration of the liquid spreading action caused by the roller application. A feature of FIG. 17 (Example 11) is that an appropriate amount of each pretreatment liquid is spotted in an expanded area on the upstream side of the roller application direction as a countermeasure against the pretreatment liquid-ink position offset. For example, in FIG. 16, the diluted pretreatment liquid is spread by two pixels, and the stock pretreatment liquid is spread by one pixel in the downstream side of the roller application. Therefore, in FIG. 17, the diluted pretreatment liquid is spotted in an area expanded by two pixels (the pixels in the third and fourth rows, and the first to fifth columns), and the stock pretreatment liquid is spotted in an area expanded by one pixel (the pixels in the fourth row, and the sixth to tenth columns) on the upstream side of the roller application.

In this way, even if the pretreatment liquid that has soaked into the fabric is spread by the roller application, it is possible to replenish the amount of the pretreatment liquid that has been spread toward the downstream side by the pretreatment liquid that is spotted in the expanded area on the upstream side of the roller application. Therefore, it is possible to effectively prevent a reduction in the image quality (edge portion sharpness) due to an insufficient amount of the pretreatment liquid such as that exhibited in the pretreatment liquid-ink position offset region in FIG. 16.

On the other hand, a feature of the reduced pretreatment liquid spotting region (two-dot chain line) on the downstream side of the roller application in FIG. 17 is that a reduced amount that is appropriate for each pretreatment liquid is spotted on the downstream side of the roller application. That is, in the reduced pretreatment liquid spotting region (two-dot chain line) in FIG. 17, the diluted pretreatment liquid is printed (spotted) in a reduced amount in two pixels (the pixels in the thirteenth to fourteen rows, and the first to fifth columns), and the stock pretreatment liquid is printed in a reduced amount in one pixel (the pixels in the fourteenth row, and the sixth to tenth columns) by respectively using the medium droplets or small droplets in FIG. 14.

The amount of the pretreatment liquid in the medium droplets and the small droplets is smaller than that in the large droplets. Therefore, the displacement amount of the pretreatment liquid that is spread by the sliding of the leveling roller also becomes smaller. Furthermore, because it is possible to replenish the pretreatment liquid in the pixels in which the medium droplets and the small droplets have been spotted from adjacent pixels in which large droplets have been spotted, insufficient color development caused by an insufficient amount of the pretreatment liquid does not occur. Therefore, it is possible to effectively reduce seepage of the pretreatment liquid to the outside of the colored ink image area without reducing the color development.

Therefore, according to the present embodiment, in addition to improving the image quality and the washing robustness by installing two or more types of pretreatment liquids, it is also possible to achieve both suppression of a reduction in the image quality (edge portion sharpness) caused by the leveling roller motion, and seepage to the outside of the colored ink image area. Furthermore, in the case of a roller (or a blade or a squeegee) in the main scanning direction, the image forming method according to the present embodiment is also achieved by a mechanism in which the carriage and the roller (or the blade or the squeegee) are integrated, and the leveling step is performed while coating the pretreatment liquid. In addition, the image forming method according to the present embodiment is also achieved by a single carriage mechanism (e.g., installing pretreatment liquid+white ink+color ink).

### Example 12

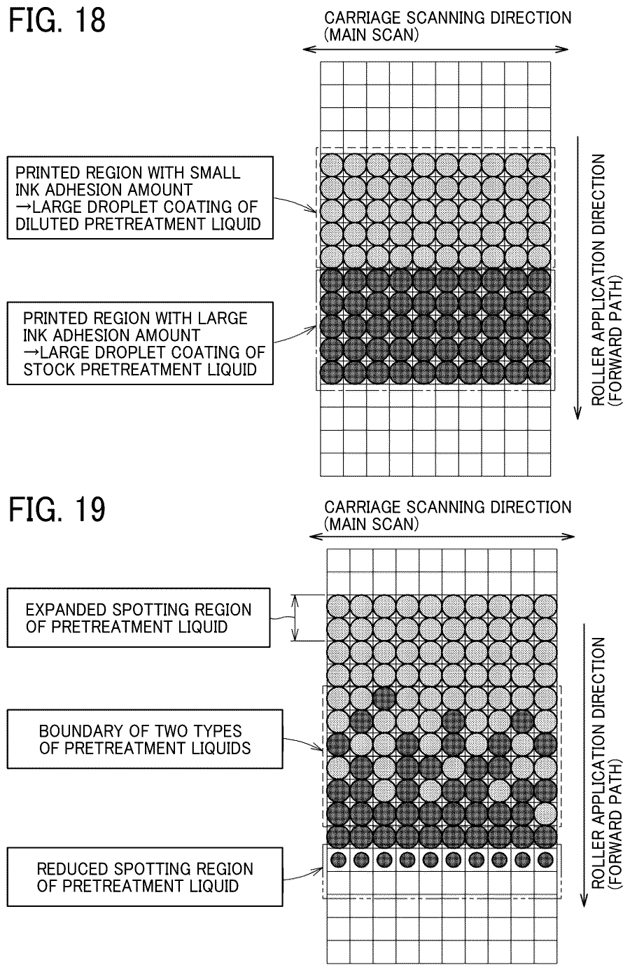

FIG. 18 illustrates a normal (conventional) pretreatment liquid coating pattern in which a large droplet coating of two types of pretreatment liquids are divided into two levels according to the ink adhesion amount. In FIG. 18, a large droplet coating of the diluted pretreatment liquid is coated so as to correspond to the printing region on the upstream side (upper level) of the roller application having a low ink adhesion amount, and a large droplet coating of the stock pretreatment liquid is coated so as to correspond to the printing region on the downstream side (lower level) of the roller application having a large ink adhesion amount.

By contrast, FIG. 19 illustrates the pretreatment liquid coating pattern according to Example 12 of the present embodiment, which considers the liquid spreading action of the roller application. On the upstream side of the roller application, the pretreatment liquids are spotted (two pixels of large droplets of the diluted pretreatment liquid) in the same manner as the expanded spotting region of the pretreatment liquid in FIG. 17. In the pretreatment liquid-ink position offset region, two pixels of the diluted pretreatment liquid are spotted in an expanded area on the upstream side of the roller application. On the other hand, in the reduced region of the pretreatment liquid on the downstream side of the roller application, the stock pretreatment liquid (medium droplets) is spotted and is reduced by one pixel.

Next, the boundary between the large droplet coating of the diluted pretreatment liquid coating on the upstream side (upper level) and the large droplet coating of the stock pretreatment liquid on the downstream side (lower level) will be described. The pretreatment liquid is replenished across the boundary from the diluted pretreatment liquid to the stock pretreatment liquid as a result of the roller application. As a result, there is a possibility that the amount of the ink aggregation component in the pretreatment liquid may become insufficient at the boundary between the diluted pretreatment liquid coating and the stock pretreatment liquid coating, and a decrease in the edge portion sharpness may occur.

This is because the concentration difference of the ink aggregation component in the pretreatment liquids (the stock and diluted solutions) is extremely large. As a countermeasure, spotting is performed with a gradation such that, for example, a ratio of the diluted pretreatment liquid to the stock pretreatment liquid toward the boundary between the two types of pretreatment liquids, as indicated by the dashed line frame in FIG. 19, becomes 1:1. That is, two or more pretreatment liquids having a different extent of dilution are spotted at the boundary region so as to be mixed. In this way, the concentration difference in the ink aggregation component in the pretreatment liquids can be reduced, and it is possible to suppress a decrease in the edge portion sharpness caused by an insufficient amount of the ink aggregation component in the pretreatment liquid at the boundary portion.

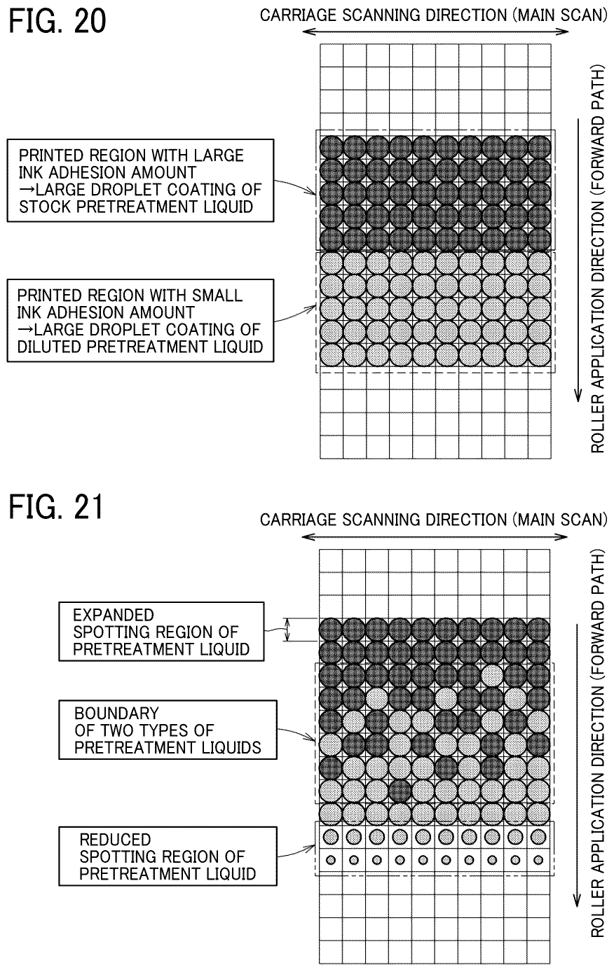

FIG. 20 illustrates a normal (conventional) pretreatment liquid coating pattern in a case where the ink adhesion amount is reversed on the upstream side and the downstream side in FIG. 18. That is, a large droplet coating of the stock pretreatment liquid is coated so as to correspond to the printing region on the upstream side (upper level) of the roller application having a large ink adhesion amount, and a large droplet coating of the diluted pretreatment liquid is coated so as to correspond to the printing region on the downstream side of the roller application having a low ink adhesion amount. In this case, the ink aggregation component in the pretreatment liquid that is replenished across the boundary from the stock pretreatment liquid to the diluted pretreatment liquid becomes excessive. This gives rise to a possibility that a decrease in washing robustness may occur due to the excessive ink aggregation component in the pretreatment liquid at the boundary of the pretreatment liquid coatings.

Therefore, the spotting is performed with a gradation such that, for example, a ratio of the diluted pretreatment liquid to the stock pretreatment liquid toward the boundary between the two types of pretreatment liquids, as indicated by the boundary of the two types of pretreatment liquids enclosed by the dashed line frame in FIG. 21, becomes 1:1. That is, two or more pretreatment liquids having a different extent of dilution are spotted at the boundary region so as to be mixed. In this way, the concentration difference in the ink aggregation component in the pretreatment liquids can be reduced, and it is possible to suppress a decrease in the washing robustness caused by an excessive ink aggregation component in the pretreatment liquid at the boundary portion.

In Example 12, the pretreatment liquids are coated with a gradation according to the roller application direction and the spotting positions of the two types of pretreatment liquids. In addition, in the case of a roller (or a blade or a squeegee) in the main scanning direction, the image forming method according to Example 12 is also achieved by a mechanism in which the carriage and the roller (or the blade or the squeegee) are integrated, and the roller application is performed while coating the pretreatment liquid. Further, the image forming method of Example 12 is also achieved by a single carriage mechanism (e.g., installing pretreatment liquid+white ink+color ink). Example 12 of the present embodiment is also achieved in a case where a blade or a squeegee is used as the leveling member instead of a roller.

### Other Examples

The present embodiment can be applied to Examples in which the carriage has an individual single carriage mechanism.

In this case, inkjet heads for the pretreatment liquid and each of the colored inks, namely white (W), cyan (C), magenta (M), yellow (Y) and black (Bk), are installed to individual carriages. When a leveling member (a roller, a blade, or a squeegee) in the main scanning direction X is used, the carriage and the leveling member can be integrated. Therefore, it is possible to perform the leveling step at the same time as applying the pretreatment liquid.

Embodiments of the present invention has been described above based on the Examples. However, embodiments of the present invention is not limited the Examples described above, and needless to say various modifications are possible within the scope of the technical ideas described in the claims. For example, the application method of the pretreatment liquid with respect to the target printing medium is not limited to inkjet spraying, and may be any coating method such as electrostatic printing.

Hereinafter, aspects of the present embodiment will be described.

### First Aspect

A first aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid; wherein the overhang region is adjacent to and upstream of the planned formation region of the printing liquid image in a movement direction of the leveling member.

### Second Aspect

A second aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form a printing liquid image with the printing liquid; wherein an application density of the pretreatment liquid in a downstream edge portion of the planned formation region of the printing liquid image in a movement direction of the leveling member is lower than an application density of the pretreatment liquid in the pretreatment liquid image excluding the downstream edge portion.

### Third Aspect

A third aspect is the printing method according to the first or second aspect, wherein the leveling member is moved in only one direction.

### Fourth Aspect

A fourth aspect is the printing method according to the first or second aspect, wherein the leveling member is moved in two directions opposite to each other without an overlap in leveled regions.

### Fifth Aspect

A fifth aspect is the printing method according to the first or second aspect, wherein the leveling member is moved in two directions opposite to each other without a partial overlap in leveled regions.

### Sixth Aspect

A sixth aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid; wherein the overhang region is adjacent to and upstream of the planned formation region of the printing liquid image in a movement direction of the leveling member, an application density of the pretreatment liquid applied in a downstream edge portion of the planned formation region of the printing liquid image in the movement direction of the leveling member is lower than an application density of the pretreatment liquid in the pretreatment liquid image excluding the downstream edge portion, and when an application density of the pretreatment liquid in the overhang region that is upstream of the planned formation region of the printing liquid image when the leveling member is moved at a pressure P with respect to the pretreatment liquid image is denoted by Da, and an application density of the pretreatment liquid in the downstream edge portion of the planned formation region of the printing liquid image is denoted by Db, Da is increased and Db is decreased as the pressure P increases, and Da is decreased and Db is increased as the pressure P decreases.

### Seventh Aspect

A seventh aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid; wherein the overhang region is adjacent to and upstream of the planned formation region of the printing liquid image in a movement direction of the leveling member, an application density of the pretreatment liquid in a downstream edge portion of the planned formation region of the printing liquid image in the movement direction of the leveling member is lower than an application density of the pretreatment liquid in the pretreatment liquid image excluding the downstream edge portion, and when an application density of the pretreatment liquid in the overhang region that is upstream of the planned formation region of the printing liquid image when the leveling member is moved at a speed V with respect to the pretreatment liquid image is denoted by Da, and an application density of the pretreatment liquid in the downstream edge portion of the planned formation region of the printing liquid image is denoted by Db, Da is increased and Db is decreased as the speed V increases, and Da is decreased and Db is increased as the speed V decreases.

### Eighth Aspect

An eighth aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid; wherein the overhang region is adjacent to and upstream of the planned formation region of the printing liquid image in a movement direction of the leveling member, an application density of the pretreatment liquid in a downstream edge portion of the planned formation region of the printing liquid image in the movement direction of the leveling member is lower than an application density of the pretreatment liquid applied in the pretreatment liquid image excluding the downstream edge portion, and when an application density of the pretreatment liquid in the overhang region that us upstream of the planned formation region of the printing liquid image when the leveling member is moved a number of repetitions N with respect to the pretreatment liquid image is denoted by Da, and an application density of the pretreatment liquid in the downstream edge portion of the planned formation region of the printing liquid image is denoted by Db, Da is increased and Db is decreased as the number of repetitions N increases, and Da is decreased and Db is increased as the number of repetitions N decreases.

### Ninth Aspect

A ninth aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the a printing liquid image with the printing liquid; wherein the overhang region is adjacent to and upstream of the planned formation region of the printing liquid image in a movement direction of the leveling member, an application density of the pretreatment liquid in a downstream edge portion of the planned formation region of the printing liquid image in a movement direction of the leveling member is lower than an application density of the pretreatment liquid in the pretreatment liquid image excluding the downstream edge portion, and when an application density of the pretreatment liquid in the overhang region that is upstream of the planned formation region of the printing liquid image when the leveling member is moved at a temperature T with respect to the pretreatment liquid image is denoted by Da, and an application density of the pretreatment liquid in the downstream edge portion of the planned formation region of the printing liquid image is denoted by Db, Da is decreased and Db is increased as the temperature T increases, and Da is increased and Db is decreased as the temperature T decreases.

### Tenth Aspect

A tenth aspect is a printing method comprising: applying a pretreatment liquid to a planned formation region of a printing liquid image and an overhang region on a target printing medium to form a pretreatment liquid image with the pretreatment liquid; moving a leveling member on the pretreatment liquid image; and applying a printing liquid to the pretreatment liquid image to form the printing liquid image with the printing liquid; wherein the overhang region is formed adjacent to and upstream of the planned formation region of the printing liquid image in a movement direction of the leveling member, an application density of the pretreatment liquid in a downstream edge portion of the planned formation region of the printing liquid image in the movement direction of the leveling member is lower than an application density of the pretreatment liquid in the pretreatment liquid image excluding the downstream edge portion, the pretreatment liquid includes two or more types of pretreatment liquids that have a different degree of dilution of a stock pretreatment liquid, resulting in a different ease of spreading by a movement of the leveling member, and when an application density of the pretreatment liquid in the overhang region that is upstream of the planned formation region of the printing liquid image is denoted by Da, and an application density of the pretreatment liquid in the downstream edge portion of the planned formation region of the printing liquid image is denoted by Db, Da is increased and Db is decreased as a pretreatment liquid becomes more easily spread by a movement of the leveling member as the ease of spreading by the movement of the leveling member of the two or more types of pretreatment liquids increases.

### Eleventh Aspect

An eleventh aspect is the printing method according to the tenth aspect, wherein as a degree of dilution of the two or more types of pretreatment liquids increases, the ease of spreading by the movement of the leveling member of the two or more types of pretreatment liquids increases.

### Twelfth Aspect

A twelfth aspect is the printing method according to the tenth aspect, wherein the application density Da or Db of the pretreatment liquid is increased or decreased according to a magnitude of a coverage rate of the pretreatment liquid covering each pixel of a planned formation region of the printing liquid image.

### Thirteenth Aspect

A thirteenth aspect is the printing method according to the tenth aspect, wherein as a printing liquid adhesion amount with respect to each pixel of a planned formation region of the printing liquid image decreases, the degree of dilution of the stock pretreatment liquid is increased.

### Fourteenth Aspect

A fourteenth aspect is a printing method according to the tenth aspect, wherein when a printing liquid adhesion amount with respect to each pixel in a planned formation region of the printing liquid image is changed between an upstream side and a downstream side in a movement direction of the leveling member, the two or more types of pretreatment liquids that differ in the degree of dilution of the stock pretreatment liquid are applied so as to be mixed at a boundary part in which the printing liquid adhesion amount changes.

### Fifteenth Aspect

A fifteenth aspect is the printing method according to any one of the first to fourteenth aspects, wherein the leveling member is any one of a leveling roller, a leveling blade, or a leveling squeegee.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. A printing method comprising:
applying a pretreatment liquid to a planned formation region of a printing liquid image and an overhang region on a target printing medium to form a pretreatment liquid image with the pretreatment liquid;
moving a leveling member on the pretreatment liquid image; and
applying a printing liquid to the pretreatment liquid image to form the printing liquid image with the printing liquid;
wherein an application density of the pretreatment liquid in a downstream edge portion of the planned formation region of the printing liquid image in a movement direction of the leveling member is lower than an application density of the pretreatment liquid in the pretreatment liquid image excluding the downstream edge portion.

2. The printing method according to claim 1, wherein the leveling member is moved in only one direction.

3. The printing method according to claim 1, wherein the leveling member is moved in two directions opposite to each other without an overlap in leveled regions.

4. The printing method according to claim 1, wherein the leveling member is moved in two directions opposite to each other with a partial overlap in leveled regions.

5. The printing method according to claim 1, wherein the leveling member is any one of a leveling roller, a leveling blade, or a leveling squeegee.
